(19) United States
(12) Patent Application Publication
(10) Pub. No.: US 2009/0237469 A1
(43) Pub. Date: Sep. 24, 2009

(54) LIQUID DELIVERY SYSTEM AND MANUFACTURING METHOD FOR THE SAME

(75) Inventors: Chiaki MIYAJIMA, Matsumoto-shi (JP); Satoshi Shinada, Shiojiri-shi (JP)

Correspondence Address: SUGHRUE MION, PLLC, 2100 Pennsylvania Avenue, N.W., Washington, DC, 20037, US

(73) Assignee: SEIKO EPSON CORPORATION, Tokyo (JP)

(21) Appl. No.: 12/403,944

(22) Filed: Mar. 13, 2009

(30) Foreign Application Priority Data
Mar. 21, 2008 (JP) 2008-073324

(51) Int. Cl. B41J 2/175; B21D 53/76

(52) U.S. Cl. 347/85; 29/890.1

(57) ABSTRACT

The liquid delivery system includes a liquid receptacle (1) installable on the liquid jetting device, a liquid supply device (900), and a liquid flow passage member (910). The liquid receptacle (1) has a liquid storage chamber for storing a liquid, a liquid delivery port for delivering the liquid to the liquid jetting device, an intermediate flow passage leading from the liquid storage chambers to the liquid delivery port, and a sensor disposed in the intermediate flow passage and adapted to sense whether the liquid is present or not. The liquid flow passage member (910) is connected to the intermediate flow passage at a location downstream of the sensor.

### CROSS-REFERENCE TO RELATED APPLICATIONS

The present application claims the priority based on Japanese Patent Application No. 2008-73324 filed on Mar. 21, 2008, the disclosure of which is hereby incorporated by reference in its entirety.

### BACKGROUND OF THE INVENTION

1. Field of the Invention

The present invention relates to a liquid delivery system for delivering liquid to a liquid jetting device, and to a method of manufacturing the same.

2. Description of the Related Art

Ink-jet printers are an example of one known class of liquid jetting device. In an ink-jet printer, ink is delivered from one or more ink cartridges. In one known conventional technology, a large-capacity ink tank is provided outside of the ink-jet printer and is connected by a tube to an ink cartridge in the printer, thereby increasing the ink storage capacity.

However, depending on the type of ink cartridge, simply connecting a tube to the ink cartridge may result in loss of ink cartridge functionality, with a possibility that ink will not be delivered appropriately to the print head of the printer. This problem is not limited to ink-jet printers, but is a problem that is common generally to liquid jetting devices or liquid-consuming devices installable of liquid receptacles.

### SUMMARY OF THE INVENTION

An object of the present invention is to provide technology for appropriate delivery of liquid to a liquid jetting device that accommodates installation of a liquid receptacle.

According to an aspect of the present invention, there is provided a method of manufacturing a liquid delivery system that delivers liquid to a liquid jetting device. The method includes the steps of: (a) providing a liquid receptacle that is installable on the liquid jetting device; (b) providing a liquid supply device for supplying the liquid receptacle with the liquid; and (c) connecting the liquid receptacle and the liquid supply device with a liquid flow passage member. The liquid receptacle may have a liquid storage chamber that stores liquid; a liquid delivery port that delivers the liquid to the liquid jetting device; an intermediate flow passage leading from the liquid storage chamber to the liquid delivery port; and a sensor, disposed in the intermediate flow passage, for sensing whether the liquid is present or not. The step (c) includes connecting the liquid flow passage member to the intermediate flow passage at a connection location downstream of the sensor. Typically, within the entire liquid flow passage, the flow passage resistance will be high at the location of the sensor which has been disposed in the intermediate flow passage. Consequently, if the liquid flow passage member is connected to the upstream side of the sensor, it is possible that replenishing liquid supplied from the liquid supply device to the liquid flow passage member will not be delivered sufficiently to the liquid jetting device, due to the high flow passage resistance at the sensor location. According to the above configuration on the other hand, because the liquid flow passage member is connected to the intermediate flow passage at a connection location downstream of the sensor, it is possible for replenishing liquid supplied from the liquid supply device via the liquid flow passage member to be delivered appropriately to the liquid jetting device.

The intermediate flow passage may have a buffer chamber located downstream of the sensor, and the liquid flow passage member may be connected to the buffer chamber. According to this configuration, the liquid flow passage member is connected to the buffer chamber of relatively large ink storage capacity, thus making connection relatively easy.

The intermediate flow passage may include: a differential pressure valve housing chamber, disposed downstream of the sensor, for housing a differential pressure valve that opens and closes responsive to a differential pressure arising through consumption of the liquid; and a vertical flow passage, disposed downstream of the differential pressure valve housing chamber, for leading the liquid to the liquid delivery port in the vertical direction. In this case, the liquid flow passage member may be connected to the vertical flow passage. According to this configuration, since the liquid flow passage member is connected to the vertical flow passage, even if air bubbles are introduced via the liquid flow passage member, the air bubbles will rise directly into the differential pressure valve chamber and become trapped there. Consequently, the likelihood of air bubbles being discharged into the liquid jetting device from the liquid delivery port situated below the vertical flow passage will be reduced.

The intermediate flow passage may include a liquid communication hole which is disposed downstream of the sensor and which is formed in a wall inside the liquid receptacle, and the liquid flow passage member may be connected to the liquid communication hole With this configuration, the liquid communication hole that has been formed in the wall of the liquid receptacle is utilized to connect the liquid flow passage member, thereby affording a simple connection procedure.

The liquid receptacle may further include an air flow passage that connects the liquid storage chamber to an outside air, and the step (c) may further include closing off the air flow passage at a location upstream of the connection location of the liquid flow passage member to the intermediate flow passage. With this configuration, air (air bubbles) will be prevented from flowing into the sensor via the air flow passage, and malfunction of the sensor will be prevented accordingly.

There are various possible modes of working the present invention, including but not limited to a liquid delivery system and a method of manufacturing the same; a liquid receptacle for use in a liquid delivery system and a method of manufacturing the same; and a liquid jetting device or a liquid consuming device, for example.

### BRIEF DESCRIPTION OF THE DRAWINGS

FIGS. 1A and 1B show an example of an on-cartridge type ink-jet printer and an ink delivery system employing the same;

FIGS. 2A and 2B show an example of an off-cartridge type ink-jet printer and an ink delivery system employing the same;

FIG. 3 is a first external perspective view of an ink cartridge;

FIG. 4 is a second external perspective view of an ink cartridge;

FIG. 5 is a first exploded perspective view of an ink cartridge;

FIG. 6 is a second exploded perspective view of an ink cartridge;

FIG. 7 is a drawing depicting an ink cartridge installed on a carriage;

FIG. 8 is a diagram depicting conceptually the pathway leading from an air vent hole to a liquid delivery port;

FIG. 9 is a drawing depicting a cartridge body from the front face side;

FIG. 10 is a drawing depicting a cartridge body from the back face side.

FIGS. 11A and 11B are diagrams of FIG. 9 and FIG. 10 in simplified form;

FIG. 12 illustrates an ink cartridge in the initial ink-filled condition;

FIGS. 13A and 13B illustrate the flow of ink within an ink cartridge;

FIGS. 14A and 14B show the A-A cross section of FIG. 13A;

FIGS. 15A and 15B illustrate flow of air within an ink cartridge;

FIGS. 16A and 16B illustrate a method of connecting an ink supply tube to an ink cartridge in Embodiment 1;

FIG. 17 is a conceptual depiction of an ink delivery system pathway in Embodiment 1;

FIGS. 18A and 18B illustrate modified examples of Embodiment 1;

FIGS. 19A and 19B illustrate a method of connecting an ink supply tube to an ink cartridge in Embodiment 2;

FIG. 20 is a drawing depicting the A-A cross section of FIG. 19A;

FIG. 21 is a conceptual depiction of an ink delivery system pathway in Embodiment 2;

FIGS. 22A and 22B illustrate a method of connecting an ink supply tube to an ink cartridge in Embodiment 3;

FIG. 23 is a drawing depicting the A-A cross section of FIG. 22A; and

FIG. 24 is a conceptual depiction of an ink delivery system pathway in Embodiment 3.

### DESCRIPTION OF THE PREFERRED EMBODIMENT

The embodiments of the present invention will be described in the order indicated below.

A. Overall Configuration of Ink Delivery System

B. Basic Configuration of Ink Cartridge

C. Configuration of Ink Cartridge for Use in Ink Delivery System and Method of Manufacturing the Same

D. Modified Examples

### A. OVERALL CONFIGURATION OF INK DELIVERY SYSTEM

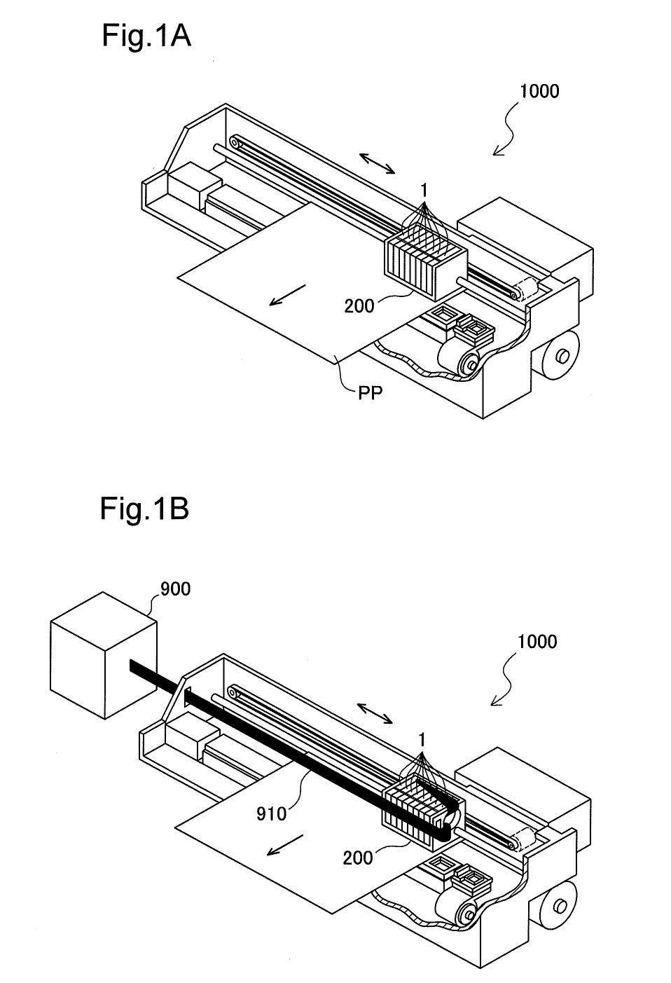

FIG. 1A is a perspective view depicting an exemplary ink-jet printer. This ink-jet printer 1000 has a carriage 200 that travels in the main scanning direction, as well as a feed mechanism for feeding printing paper PP in the sub-scanning direction. A print head (not shown) is disposed at the lower end of the carriage 200, and this print head is used to carry out printing on the printing paper PP. A cartridge housing capable of accommodating multiple ink cartridges 1 is provided on the carriage 200. This kind of printer, in which the ink cartridges are installed on the carriage, is termed an “on-carriage type printer.”

FIG. 1B depicts an ink delivery system that employs this ink-jet printer 1000. In this system, large-capacity ink tank 900 is provided externally to the ink-jet printer 1000, with the large-capacity ink tank 900 and the ink cartridges 1 being connected by ink supply tubes 910. The large-capacity ink tank 900 contains ink receptacles equal in number to the number of ink cartridges 1. By providing this additional large-capacity ink tank 900, the ink storage capacity of the printer can be substantially increased appreciably. The large-capacity ink tank 900 is also referred to as an “external ink tank.”

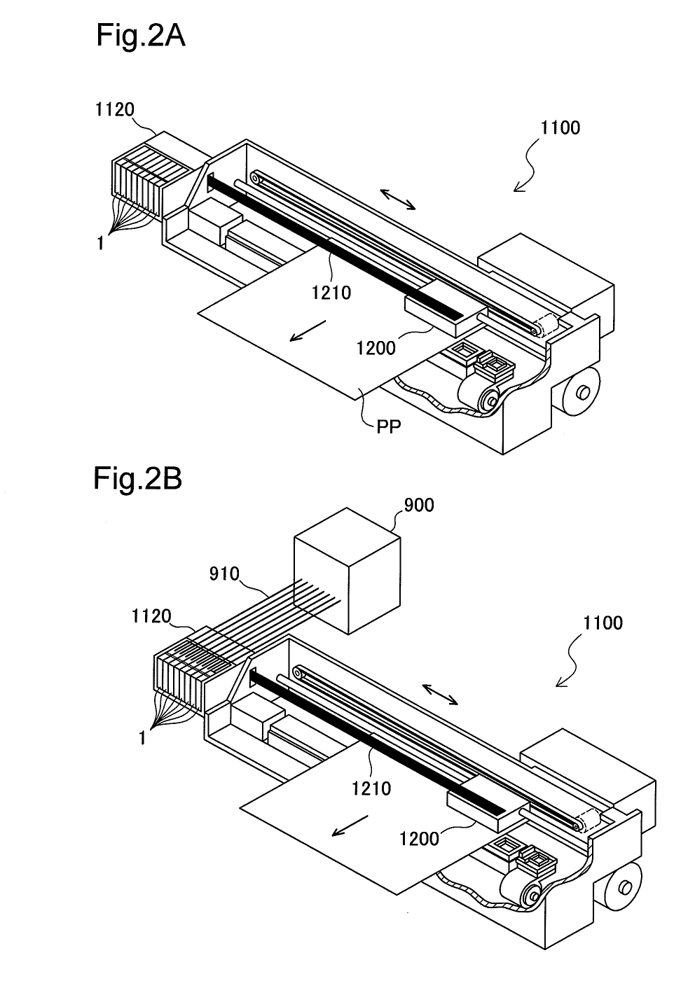

FIG. 2A is a perspective view depicting another exemplary ink-jet printer. In this ink-jet printer 1110, the ink cartridges are not installed on the carriage 1200, but rather are disposed in a cartridge housing 1120 to the outside of the printer chassis (to the outside of the range of travel of the carriage). The ink cartridges 1 and the carriage 1200 are connected by ink delivery tubes 1210. This kind of printer, in which the ink cartridges are installed at a location other than the carriage, is termed an “off-carriage type printer.”

FIG. 2B depicts an ink delivery system that employs this ink-jet printer 1100. In this system, an additional large-capacity ink tank 900 is provided, and the large-capacity ink tank 900 and the ink cartridges 1 are connected by ink supply tubes 910. Thus, for this type of off-carriage printer as well, by the same method as with the on-carriage type printer it will be possible to design an ink delivery system having appreciably larger ink storage capacity.

Herein the system composed of the ink cartridges 1, the large-capacity ink tank 900, and the ink supply tubes 910 will be referred to as the “ink delivery system.” In some instances, the entire system inclusive of the ink-jet printer will be referred to as the “ink delivery system.”

Following is a description first of the design of the ink cartridges that are utilized in the embodiments of the ink delivery system herein; followed by a description of the detailed configuration of the ink delivery system and of a method for manufacturing it. While the following description relates for the most part to the use of an on-carriage type printer, the specifics thereof are applicable analogously to an ink-jet printer of off-carriage type.

### B. BASIC CONFIGURATION OF INK CARTRIDGE

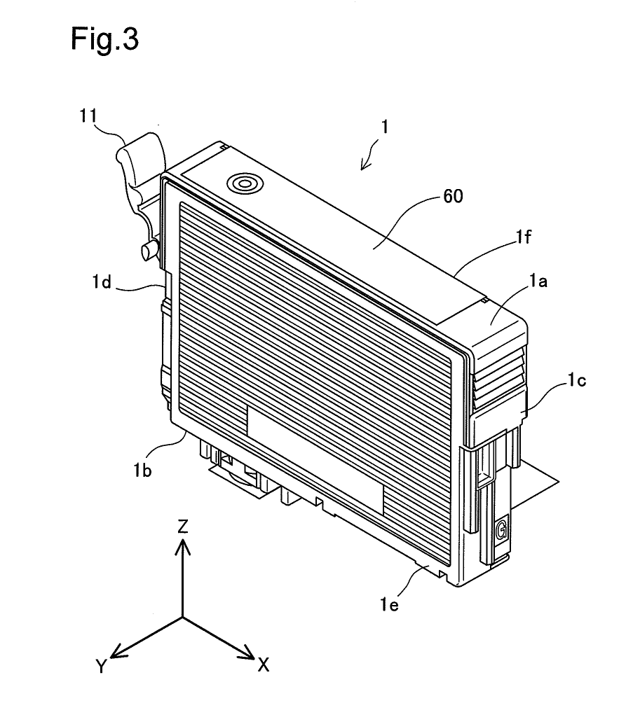

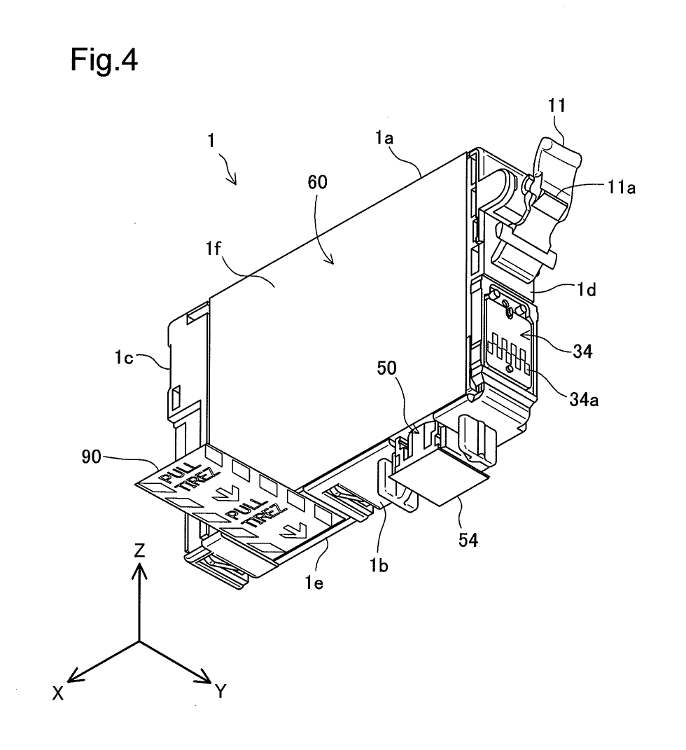

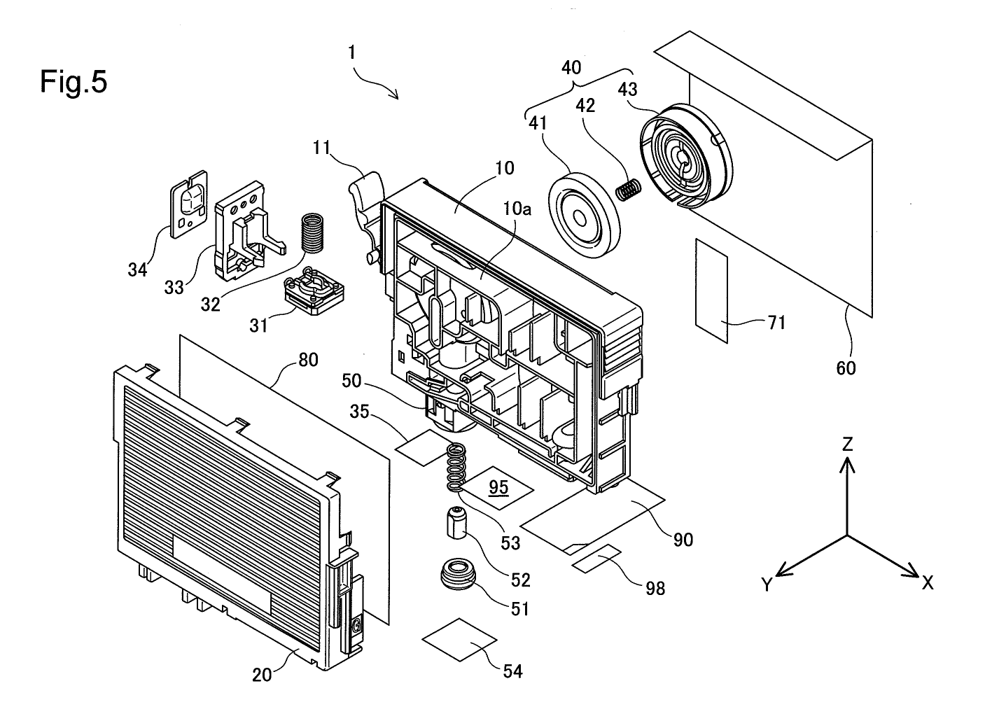

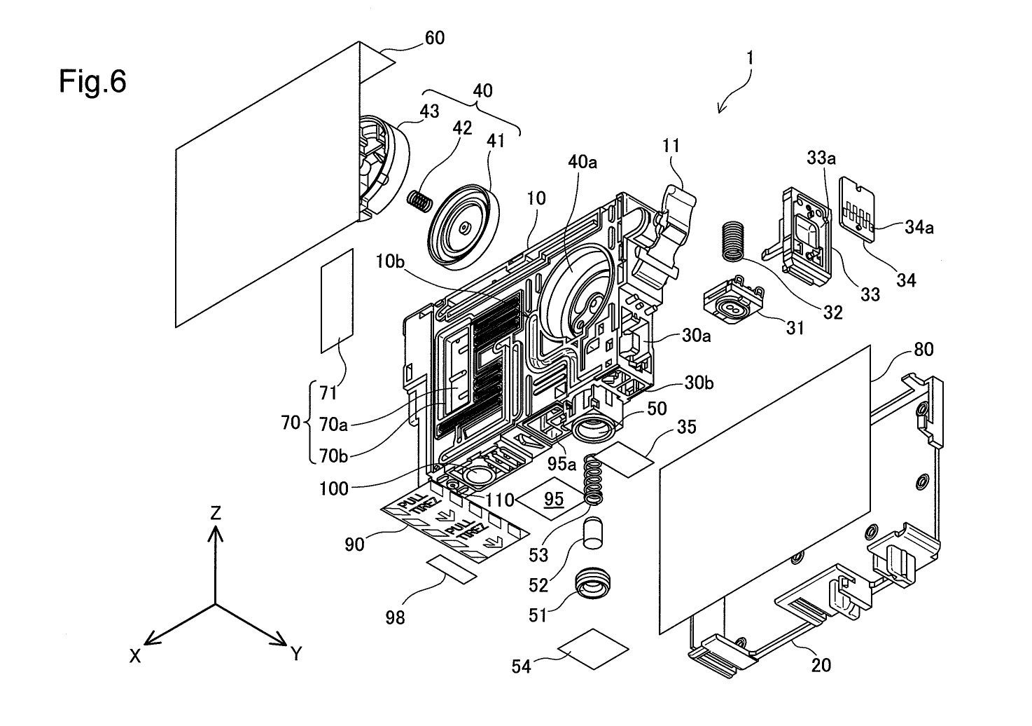

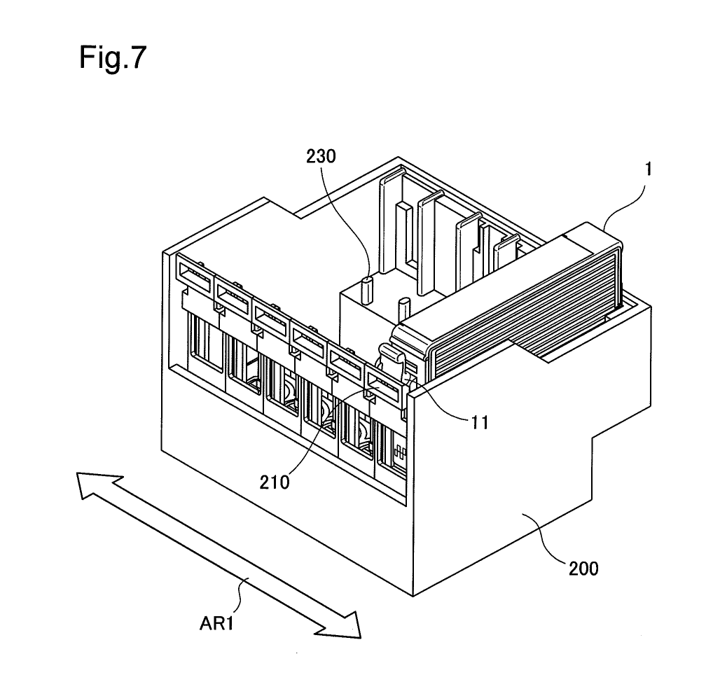

FIG. 3 is a first external perspective view of an ink cartridge. FIG. 4 is a second external perspective view of an ink cartridge. FIG. 4 depicts the cartridge of FIG. 3 viewed from the opposite direction. FIG. 5 is a first exploded perspective view of an ink cartridge. FIG. 6 is a second exploded perspective view of an ink cartridge. FIG. 6 depicts the cartridge of FIG. 5 viewed from the opposite direction. FIG. 7 depicts an ink cartridge installed in the carriage 200. In FIGS. 3 to 6, the X, Y, and Z axes are shown in order to identify direction.

The ink cartridge 1 stores liquid ink inside. As depicted in FIG. 7, the ink cartridge 1 is installed on the carriage 200 of the ink-jet printer, and delivers ink to the print head of the ink-jet printer.

As depicted in FIGS. 3 and 4, the ink cartridge 1 has generally rectangular parallelepiped contours, and has a Z-axis positive direction face 1a, a Z-axis negative direction face 1b, an X-axis positive direction face 1c, an X-axis negative direction face 1d, a Y-axis positive direction face 1e, and a Y-axis negative direction face 1f. For convenience, hereinbelow face 1a will be termed the top face, face 1b the bottom face, face 1c the right face, face 1d the left face, face 1e the front face, and face 1f the back face. The sides on which these faces 1a to 1f are located will be respectively termed the top face side, the bottom face side, the right face side, the left face side, the front face side, and the back face side.

On the bottom face 1b there is disposed a liquid delivery port 50 having a delivery hole for delivering ink to the ink-jet printer. Also, an air vent hole 100 for introducing air into the ink cartridge 1 opens onto the bottom face 1b (FIG. 6).

The air vent hole 100 has a depth and diameter such that a projection 230 (FIG. 7) that has been formed on the carriage 200 of the ink-jet printer will fit within it, with enough latitude to have a prescribed gap. The user will peel off a sealing film 90 that airtightly seals the air vent hole 100, then install the ink cartridge 1 on the carriage 200. The projection 230 is provided in order to prevent the user from forgetting to peel off the sealing film 90.

As depicted in FIGS. 3 and 4, a locking lever 11 is disposed on the left face 1d. A projection 11a is formed on the locking lever 11. During installation on the carriage 200, the projection 11a will lock in a recess 210 that has been formed on the carriage 200, thereby securing the ink cartridge 1 to the carriage 200 (FIG. 7). As will be appreciated from the above, the carriage 200 constitutes an installation portion on which the ink cartridges 1 are installed. During printing by the ink-jet printer, the carriage 200, in unison with the print head (not shown), undergoes reciprocating motion across the width of the printing medium in the main scanning direction. The main scanning direction is indicated by arrow ARI in FIG. 7. Specifically, when the ink-jet printer carries out printing the ink cartridges 1 will be undergo reciprocating motion in the Y direction in the drawings.

A circuit board 34 is disposed to the lower side of the locking lever 11 on the left face id (FIG. 4). Several electric terminals 34 have been formed on the circuit board 34; these electric terminals 34 electrically connect to the ink-jet printer via electric terminal pins (not shown) provided on the carriage 200.

An outer surface film 60 is adhered to the top face 1a and the back face if of the ink cartridge 1.

The internal configuration and configuration of parts of the ink cartridge 1 will be described with reference to FIGS. 5 and 6. The ink cartridge 1 has a cartridge body 10, and a cover member 20 covering the front face side of the cartridge body 10.

Ribs 10a of various shapes have been formed on the front face side of the cartridge body 10 (FIG. 5). A film 80 that covers the front face side of the cartridge body 10 is positioned between the cartridge body 10 and the cover member 20. The film 80 is adhered carefully to the edge faces on the front face side of the ribs 10a of the cartridge body 10 so as to prevent gaps from forming. The ribs 10a and the film 80 serve to divide the interior of the ink cartridge 1 into a plurality of small chambers, for example, ink storage chambers and a buffer chamber. These chambers will be discussed in more detail later.

A differential pressure valve housing chamber 40a and a vapor-liquid separation chamber 70a are formed to the back face side of the cartridge body 10 (FIG. 6). The differential pressure valve housing chamber 40a houses a differential pressure valve 40, which includes a valve member 41, a spring 42, and a spring seat 43. A ledge 70b is formed on the inner wall that encloses the bottom face of the vapor-liquid separation chamber 70a, and a vapor-liquid separation membrane 71 is adhered to the ledge 70b; this arrangement in its entirety constitutes a vapor-liquid separation filter 70.

A plurality of grooves 10b are also formed to the back face side of the cartridge body 10 (FIG. 6). When the outer surface film 60 is disposed so as to cover substantially the entire back face side of the cartridge body 10, these grooves 10b will define various flow passages (discussed later) between the cartridge body 10 and the outer surface film 60, for example, flow channels through which ink and air may flow.

Next, the arrangement in the vicinity of the circuit board 34 mentioned earlier will be described. A sensor housing chamber 30a is formed to the lower face side of the right face of the cartridge body 10 (FIG. 6). The sensor housing chamber 30a houses a liquid level sensor 31 and a fastening spring 32. The fastening spring 32 fastens the liquid level sensor 31 by pushing it against the inside wall on the lower face side of the sensor housing chamber 30. An opening on the right face side of the sensor housing chamber 30 is covered by a cover member 33, and the circuit board 34 mentioned earlier is fastened to the outside face 33a of the cover member 33. The sensor housing chamber 30a, the liquid level sensor 31, the fastening spring 32, the circuit board 34, and a sensor flow passage forming chamber 30b, discussed later, will be referred to as the sensor section 30.

While not illustrated in detail, the liquid level sensor 31 includes a cavity that defines part of the intermediate flow passage (to be discussed later); an oscillating plate that defines part of the wall of the cavity; and a piezoelectric element arranged on the oscillating plate. The terminals of the piezoelectric element are connected electrically to some of the electric terminals of the circuit board 34; and with the ink cartridge 1 installed in the ink-jet printer, the terminals of the piezoelectric element will be electrically connected to the ink-jet printer via electric terminals of the circuit board 34. By applying electrical energy to the piezoelectric element, the ink-jet printer can induce oscillation of the oscillating plate through the agency of the piezoelectric element. The presence of any air bubbles in the cavity will be ascertained through subsequent detection, through the agency of the piezoelectric element, of a characteristic (frequency etc.) of residual vibration of the oscillating plate. Specifically, when due to consumption of the ink stored in the cartridge body 10, the state inside the cavity changes from an ink-filled state to an air-filled state, there will be a change in the characteristics of residual vibration of the oscillating plate. By detecting this change in characteristics of residual vibration via the liquid level sensor 31, the ink-jet printer detects whether ink is present in the cavity.

The circuit board 34 is provided with a rewritable nonvolatile memory such as EEPROM (Electronically Erasable and Programmable Read Only Memory), which is used to store parameters such as the amount of ink consumed by the ink-jet printer.

On the bottom face side of the cartridge body 10 there are disposed the liquid delivery port 50 and the air vent hole 100 mentioned previously, as well as a depressurization hole 110, a sensor flow passage forming chamber 30b, and a labyrinthine passage forming chamber 95a (FIG. 6). The depressurization hole 110 is utilized during injection of the ink in the ink cartridge 1 manufacturing process, in order to suck out air and depressurize the interior of the ink cartridge 1. The sensor flow passage forming chamber 30b and the labyrinthine passage forming chamber 95a constitute parts of the intermediate flow passage, discussed later. The sensor flow passage forming chamber 30b and the labyrinthine passage forming chamber 95a are the sections that are narrowest and have the highest flow resistance in the intermediate flow passage. In particular, the labyrinthine passage forming chamber 95 defines a flow passage of labyrinthine configuration, and produces a meniscus (a liquid bridge that forms in the flow passage), and therefore the flow resistance is particularly high in this section.

The openings of the liquid delivery port 50, the air vent hole 100, the depressurization hole 110, the labyrinthine passage forming chamber 95a, and the sensor flow passage forming chamber 30b will be respectively sealed off by sealing films 54, 90, 98, 95, 35 upon completion of manufacture of the ink cartridge 1. Of these, the sealing film 90 is intended to be peeled off by the user prior to installing the ink cartridge 1 in the carriage 200 as described earlier. By so doing, the air vent hole 100 will communicate with the outside, allowing air to be introduced into interior of the ink cartridge 1. The sealing film 54 is designed to be ruptured by an ink delivery needle 240 provided on the carriage 200 when the ink cartridge 1 is installed in the carriage 200 of the ink-jet printer.

In the interior of the liquid delivery port 50 are housed, in order from the lower face side, a seal member 51, a spring seat 52, and a blocking spring 53. When the ink delivery needle 240 has been inserted into the liquid delivery port 50, the seal member 51 will function to seal the gap between the inside wall of the liquid delivery port 50 and the outside wall of the ink delivery needle 240. The spring seat 52 is adapted to contact the inside wall of the seal member 51 and block off the liquid delivery port 50 when the ink cartridge 1 is not installed in the carriage 200. The blocking spring 53 is adapted to urge the spring seat 52 in the direction of contact with the inside wall of the seal member 51. When the ink delivery needle 240 is inserted into the liquid delivery port 50, the upper end of the ink delivery needle 240 will push up the spring seat 52 and create a gap between the spring seat 52 and the seal member 51 so that ink is delivered to the ink delivery needle 240 through this gap.

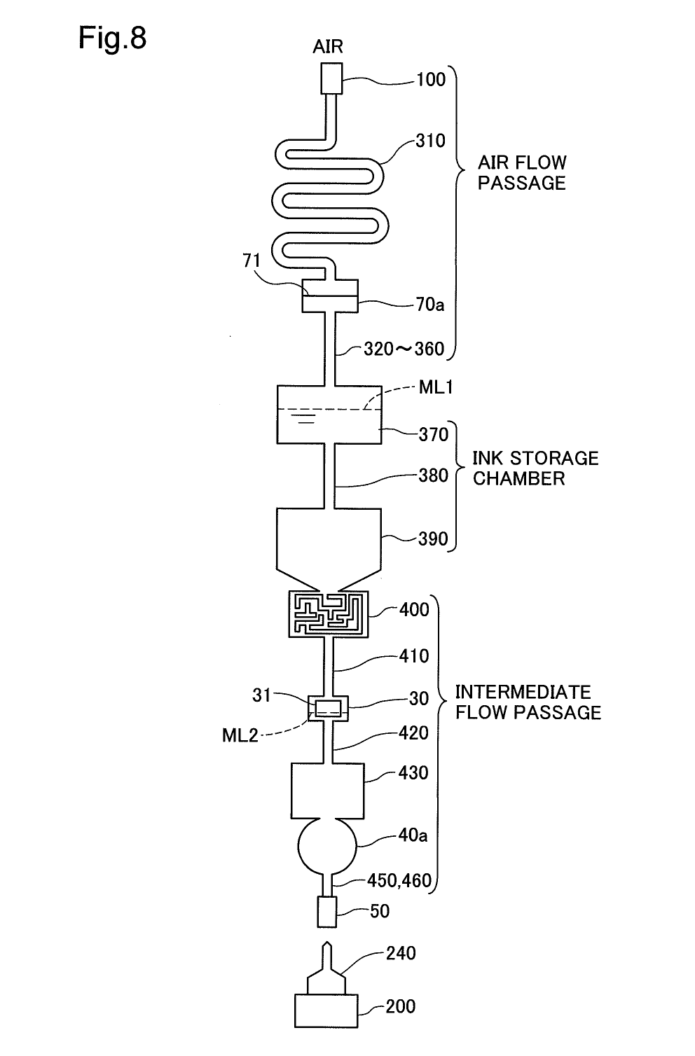

Next, before proceeding to a more detailed description of the internal structure of the ink cartridge 1, for purposes of aiding understanding, the pathway leading from the air vent hole 100 to the liquid delivery port 50 will be described in conceptual terms with reference to FIG. 8. FIG. 8 is a diagram depicting conceptually the pathway leading from the air vent hole to the liquid delivery port.

The pathway leading from the air vent hole 100 to the liquid delivery port 50 will be broadly divided into ink storage chambers for holding ink, an air flow passage situated on the upstream side of the ink storage chambers, and an intermediate flow passage situated on the downstream side of the ink storage chambers.

The ink storage chambers include, in order from the upstream side, a first ink holding chamber 370, a holding chamber connector passage 380, and a second ink holding chamber 390. The upstream end of the holding chamber connector passage 380 communicates with the first ink holding chamber 370, while the downstream end of the holding chamber connector passage 380 communicates with the second ink holding chamber 390.

The air flow passage includes, in order from the upstream side, a serpentine passage 310, a vapor-liquid separation chamber 70a that houses the vapor-liquid separation membrane 71 discussed earlier, and connecting paths 320 to 360 that connect the vapor-liquid separation chamber 70a with the ink storage chamber. The serpentine passage 310 communicates at its upstream end with the air vent hole 100, and at its downstream end with the vapor-liquid separation chamber 70a. The serpentine passage 310 is elongated and extends in a sinuous configuration so as to maximize the distance from the air vent hole 100 to the first ink holding chamber 370. Through this arrangement, evaporation of moisture from the ink inside the ink storage chambers will be kept to a minimum. The vapor-liquid separation membrane 71 is constructed of material that permits vapor to pass, but does not allow liquid to pass. By situating the vapor-liquid separation membrane 71 between the upstream end and the downstream end of the vapor-liquid separation chamber 70a, ink backflowing from the ink storage chambers will be prevented from advancing upstream beyond the vapor-liquid separation chamber 70a. The specific configuration of the connecting paths 320 to 360 will be discussed later.

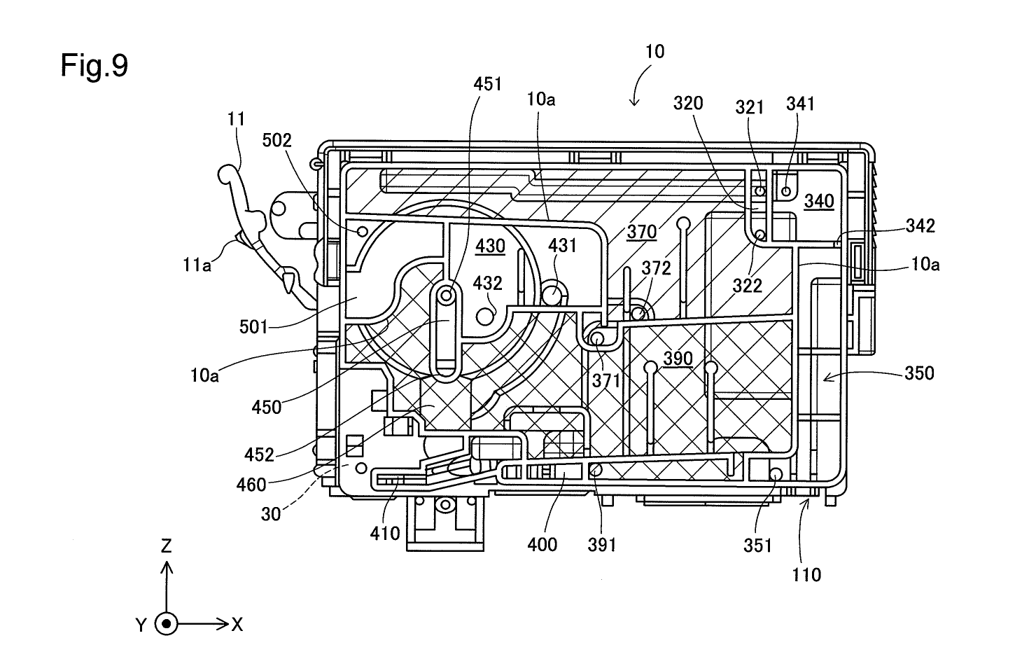

The intermediate flow passage includes, in order from the upstream side, a labyrinthine flow passage 400, a first flow passage 410, the aforementioned sensor section 30, a second flow passage 420, a buffer chamber 430, the aforementioned differential pressure valve housing chamber 40a housing the differential pressure valve 40, and third flow passages 450, 460. The labyrinthine flow passage 400 has a three-dimensional labyrinthine configuration and includes the space defined by the aforementioned labyrinthine passage forming chamber 95a. Through the labyrinthine flow passage 400, air bubbles entrained in the ink will be trapped so as to prevent air bubbles from being entrained in the ink downstream from the labyrinthine flow passage 400. The labyrinthine flow passage 400 is also termed an “air bubble trap flow passage.” The first flow passage 410 communicates at its upstream end with the labyrinthine flow passage 400, and communicates at its downstream end with the sensor flow passage forming chamber 30b of the sensor section 30. The second flow passage 420 communicates at its upstream end with the sensor flow passage forming chamber 30b of the sensor section 30, and at its downstream end with the buffer chamber 430. The buffer chamber 430 communicates directly with the differential pressure valve housing chamber 40a with no intervening flow passage. Thus, the space from the buffer chamber 430 to the liquid delivery port 50 is minimized, and the likelihood of ink accumulating and settling out in that space will be reduced. In the differential pressure valve housing chamber 40a, through the action of the differential pressure valve 40, the pressure of the ink to the downstream side of the differential pressure valve housing chamber 40a will be maintained to be lower than the ink pressure on the upstream side, so that the ink in the downstream side assumes negative pressure. The third flow passages 450, 460 (see FIG. 9) communicate at the upstream side with the differential pressure valve housing chamber 40a and at the downstream side with the liquid delivery port 50. These third flow passages 450, 460 define vertical flow passages through which ink exiting the differential pressure valve housing chamber 40a will be guided vertically downward and into the liquid delivery port 50.

At the time of manufacture of the ink cartridge 1, the cartridge will be filled up to the first ink holding chamber 370, as indicated by the liquid level depicted conceptually by the broken line ML1 in FIG. 8. In the absence of an additional large-capacity ink tank 900 (FIGS. 1A, 1B, 2A, 2B), as the ink inside the ink cartridge 1 is consumed by the ink-jet printer the liquid level will move towards the downstream end and it will be replaced by air flowing into the ink cartridge 1 from the upstream end through the air vent hole 100. As ink consumption progresses, the liquid level will reach the sensor section 30 indicated by the liquid level depicted conceptually by the broken line ML2 in FIG. 8. At this point, air will enter the sensor section 30, and ink depletion will be detected by the liquid level sensor 31. Once ink depletion has been detected, the ink jet printer will halt printing and alert the user at a stage before the ink present to the downstream side of the sensor section 30 (in the buffer chamber 430 etc.) is completely consumed. This is because if the ink is totally depleted, when it is attempted to continue further printing there is a risk that air may be drawn into the print head and cause problems.

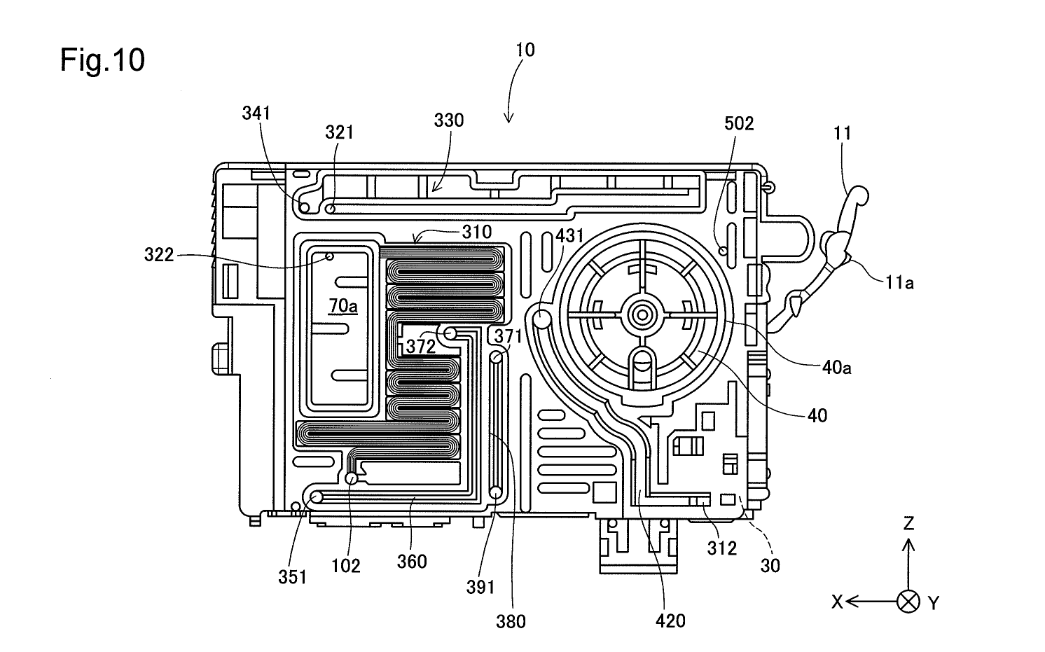

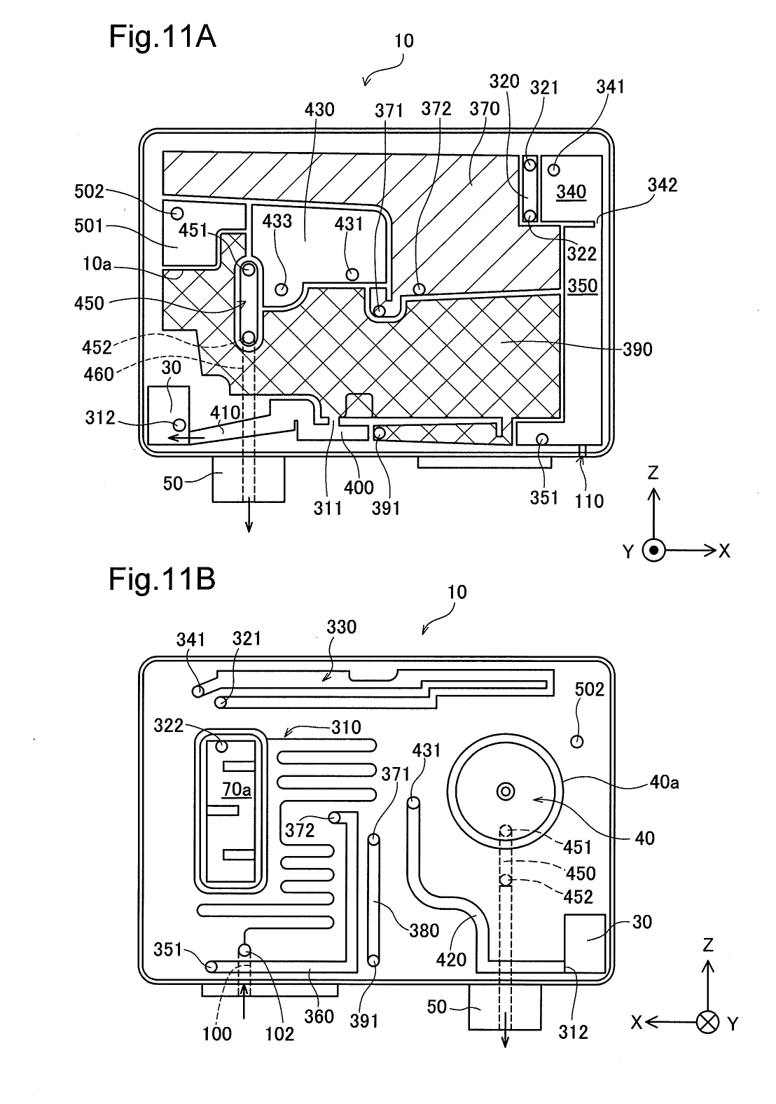

The specific configuration of each element on the pathway from the air vent hole 100 to the liquid delivery port 50 within the ink cartridge 1 will be described with reference to FIGS. 9 to 11B. FIG. 9 is a drawing depicting the cartridge body 10 from the front face side. FIG. 10 is a drawing depicting the cartridge body 10 from the back face side. FIG. 11A is a model diagram of FIG. 9 in simplified form. FIG. 11B is a model diagram of FIG. 10 in simplified form.

In the ink storage chambers, the first ink holding chamber 370 and the second ink holding chamber 390 are formed on the front face side of the cartridge body 10. In FIG. 9 and FIG. 11A, the first ink holding chamber 370 and the second ink holding chamber 390 are shown respectively by single hatching and crosshatching. The holding chamber connector passage 380 is formed on the back face side of the cartridge body 10, at the location shown in FIG. 10 and FIG. 11B. A communication hole 371 is provided to connect the upstream end of the holding chamber connector passage 380 with the first ink holding chamber 370, and a communication hole 391 is provided to connect the downstream end of the holding chamber connector passage 380 with the second ink holding chamber 390.

In the air flow passage, the serpentine passage 310 and the vapor-liquid separation chamber 70a are formed on the back face side of the cartridge body 10, at the respective locations shown in FIG. 10 and FIG. 11B. A communication hole 102 is provided to connect the upstream end of the serpentine passage 310 with the air vent hole 100. The downstream end of the serpentine passage 310 passes through the side wall of the vapor-liquid separation chamber 70a and communicates with the vapor-liquid separation chamber 70a.

Turning now to a more detailed description of the connecting paths 320 to 360 of the air flow passage depicted in FIG. 8, these are composed of a first space 320, a third space 340, and a fourth space 350 situated on the front face side of the cartridge body 10 (see FIG. 9 and FIG. 11A), and a second space 330 and a fifth space 360 situated on the back face side of the cartridge body 10 (see FIG. 10 and FIG. 11B), these spaces being situated in-line, in order of their assigned symbols from the upstream end, to define a single flow passage. A communication hole 322 is provided to connect the vapor-liquid separation chamber 70a to the first space 320. Communication holes 321, 341 are provided to connect the first space 320 with the second space 330, and the second space 330 with the third space 340, respectively. The third space 340 and the fourth space 350 communicate with one another through a notch 342 that has been formed in the rib separating the third space 340 and the fourth space 350. Communication holes 351, 372 are provided to connect the fourth space 350 with the fifth space 360, and the fifth space 360 with the first ink holding chamber 370, respectively.

In the intermediate flow passage, the labyrinthine flow passage 400 and the first flow passage 410 are formed on the front face side of the cartridge body 10 at the respective locations shown in FIG. 9 and FIG. 11A. A communication hole 311 is provided in the rib that separates the second ink holding chamber 390 from the labyrinthine flow passage 400, and connects the second ink holding chamber 390 with the labyrinthine flow passage 400. As discussed previously with reference to FIG. 6, the sensor section 30 is situated on the lower face side of the right face of the cartridge body 10 (FIGS. 9 to 11B). The second flow passage 420 and the aforementioned vapor-liquid separation chamber 70a are formed on the back face side of the cartridge body 10 at the respective locations shown in FIG. 10 and FIG. 11B. The buffer chamber 430 and the third flow passage 450 are formed on the front face side of the cartridge body 10 at the respective locations shown in FIG. 9 and FIG. 11A. A communication hole 312 is provided to connect the labyrinthine passage forming chamber 95a (FIG. 6) of the sensor section 30 with the second flow passage 420; and a communication hole 431 is provided to connect the downstream end of the second flow passage 420 with the buffer chamber 430. A communication hole 432 is provided to directly connect the buffer chamber 430 with the differential pressure valve housing chamber 40a. Communication holes 451,452 are provided to respectively connect the differential pressure valve housing chamber 40a with the third flow passage 450, and the third flow passage 450 with the ink delivery hole inside the liquid delivery port 50. As mentioned earlier, in the intermediate flow passage, the labyrinthine flow passage 400 and the sensor section 30 (the labyrinthine passage forming chamber 95a and the sensor flow passage forming chamber 30b of FIG. 5) are the sections of the flow passage in which flow resistance is highest.

A space 501 shown in FIG. 9 and FIG. 11A is an unfilled space that is not filled with ink. The unfilled space 501 is not situated on the pathway leading from the air vent hole 100 to the liquid delivery port 50, but is rather independent. An outside air communication hole 502 that communicates with the outside air is formed on the back face side of the unfilled space 501. The unfilled space 501 serves as a degassing space that is brought to negative pressure when the ink cartridge 1 is packaged in a vacuum pack. Thus, as long as the ink cartridge 1 is kept in the package, the inside pressure of the cartridge body 10 will be maintained below a prescribed pressure value so that the cartridge can deliver ink with negligible dissolved air.

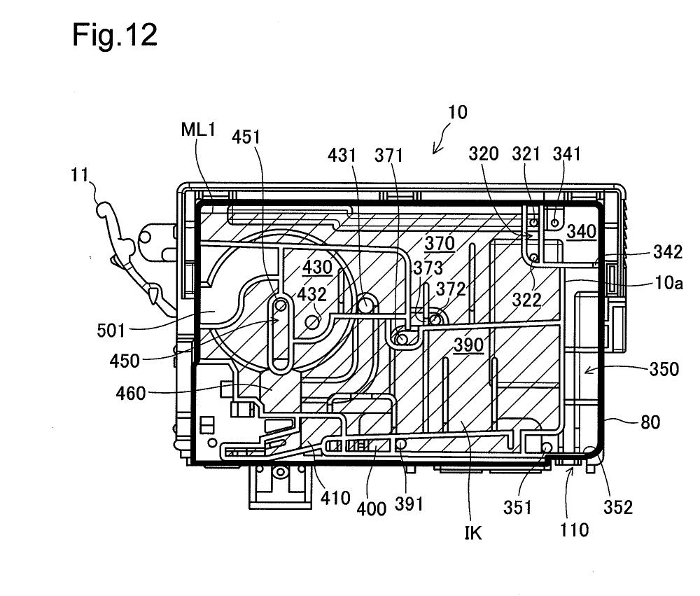

FIG. 12 is an illustration depicting an ink cartridge in the initial ink-filled condition (factory condition). Here, the film 80 is shown joined along the wall edges indicated by the heavy solid line, and also joined on the other inner wall edges; the ink is held inside of these walls. A liquid level ML1 is shown here, and the section containing the ink IK is indicated by hatching. Specifically, of the ink storage chambers 370, 380, 390 (see FIG. 8), the liquid level ML1 will be situated in the upper part of the first ink holding chamber 370 which lies furthest towards the upstream end, with air being present above this level. Typically, as the ink in the cartridge is consumed, this liquid level ML1 will gradually drop. However, once the additional large-capacity ink tank 900 (FIGS. 1B, 2B) has been installed, there will be no change in liquid level in the ink cartridge.

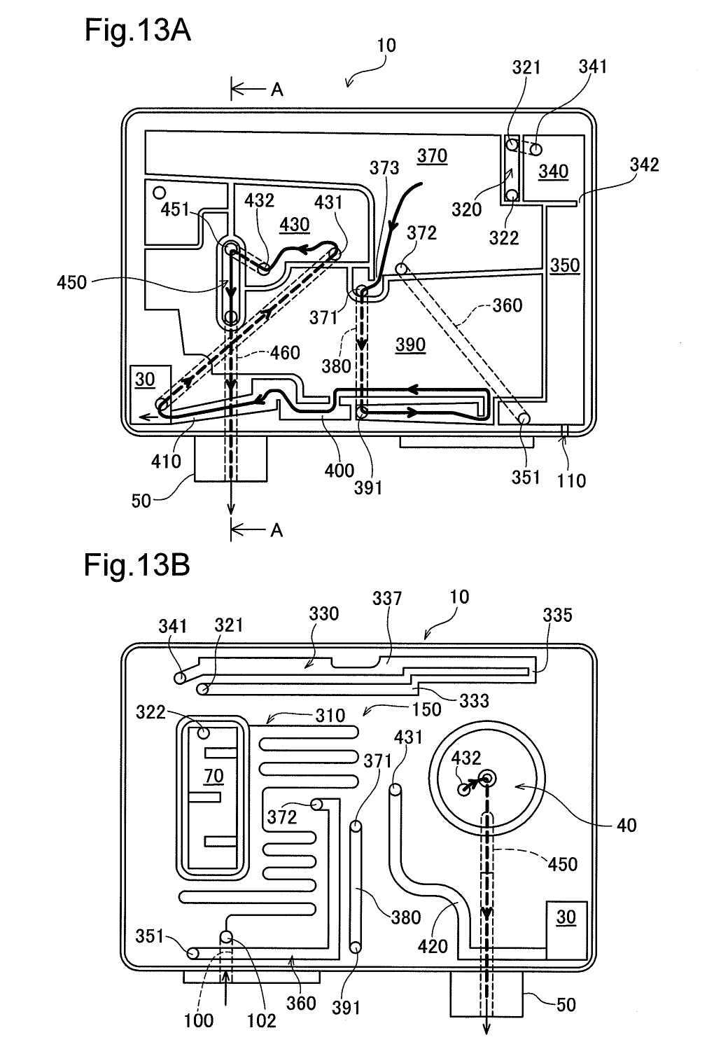

FIGS. 13A and 13B illustrate the flow of ink within an ink cartridge. Here, the ink flow path from the first ink holding chamber 370 to the liquid delivery port 50 is shown by thick solid lines and broken lines. This ink flow path can be understood as a more detailed rendering of the path through the ink storage chamber and the intermediate flow passage depicted in FIG. 8.

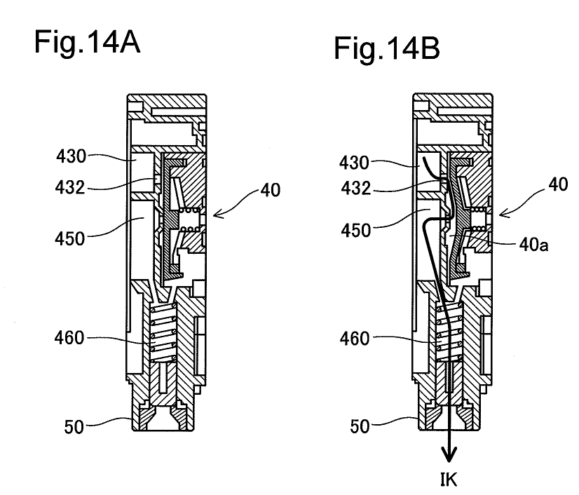

FIGS. 14A and 14B show the A-A cross section of FIG. 13A. The drawings depict the section that includes the differential pressure valve 40, the buffer chamber 430 at the upstream side of the differential pressure valve 40, and the vertical passages 450, 460 at the downstream side of the differential pressure valve 40. For convenience in illustration, the communication hole 432 that connects the buffer chamber 430 with the differential pressure valve chamber 40a is depicted as being at a location somewhat further towards the upper side than in FIG. 13A. FIG. 14A depicts the differential pressure valve 40 in the closed state. As the ink head consumes ink, the pressure on the liquid delivery port 50 side will drop and the differential pressure valve 40 will assume the open state as depicted in FIG. 14B. Once the differential pressure valve 40 opens, ink IK will flow from the buffer chamber 430 into the differential pressure valve housing chamber 40a through the communication hole 432, and thence through the vertical passages 450, 460 so that the ink IK is delivered from the liquid delivery port 50 to the print head. Utilizing the differential pressure valve 40, the delivery pressure of ink delivered to the print head will be maintained within an appropriate pressure range, whereby it is possible for ejection of ink from the print head to take place under stable conditions. As will be understood from the preceding discussion, the buffer chamber 430 is disposed to the immediate front of the differential pressure valve 40, and functions as a chamber for storing ink to be introduced into the differential pressure valve 40.

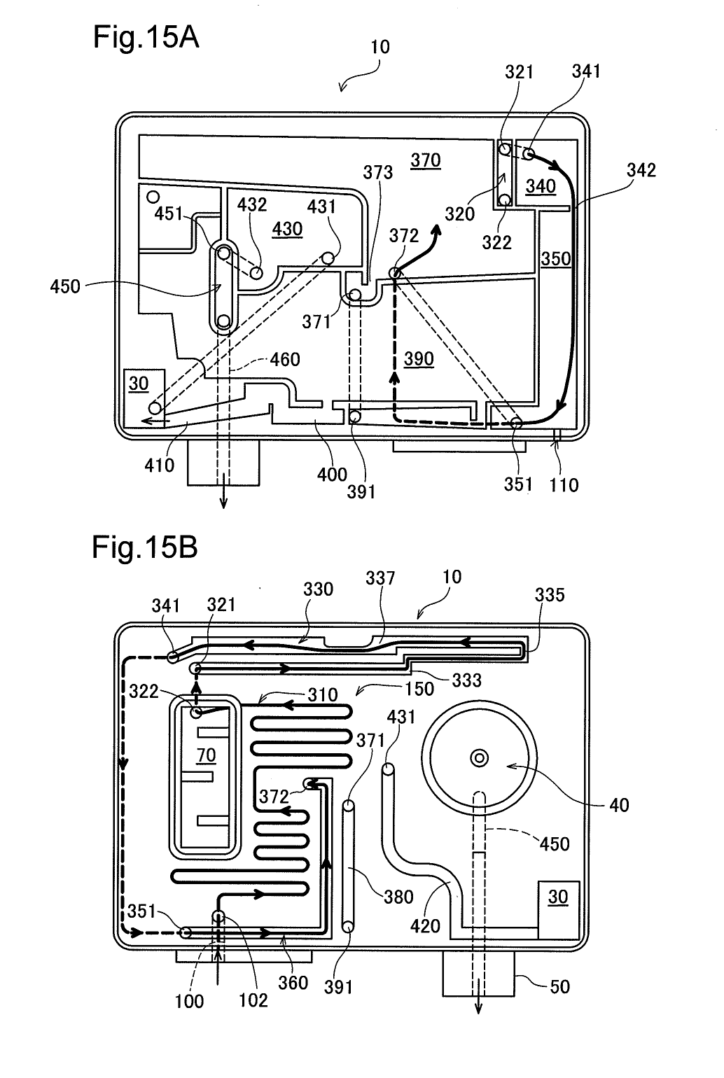

FIGS. 15A and 15B illustrate the flow of air within an ink cartridge. Here, the pathway of air flow from the air vent hole 100 (FIG. 15B) to the first ink holding chamber 370 is shown by thick solid lines and broken lines. This pathway of air flow can be understood as a more detailed rendering of the air flow path depicted in FIG. 8.

The discussion now turns to a method of manufacturing an ink delivery system (FIG. 1B, FIG. 2B) that employs the ink cartridge described above.

### C. CONFIGURATION OF INK CARTRIDGE FOR USE IN INK DELIVERY SYSTEM AND METHOD OF MANUFACTURING THE SAME

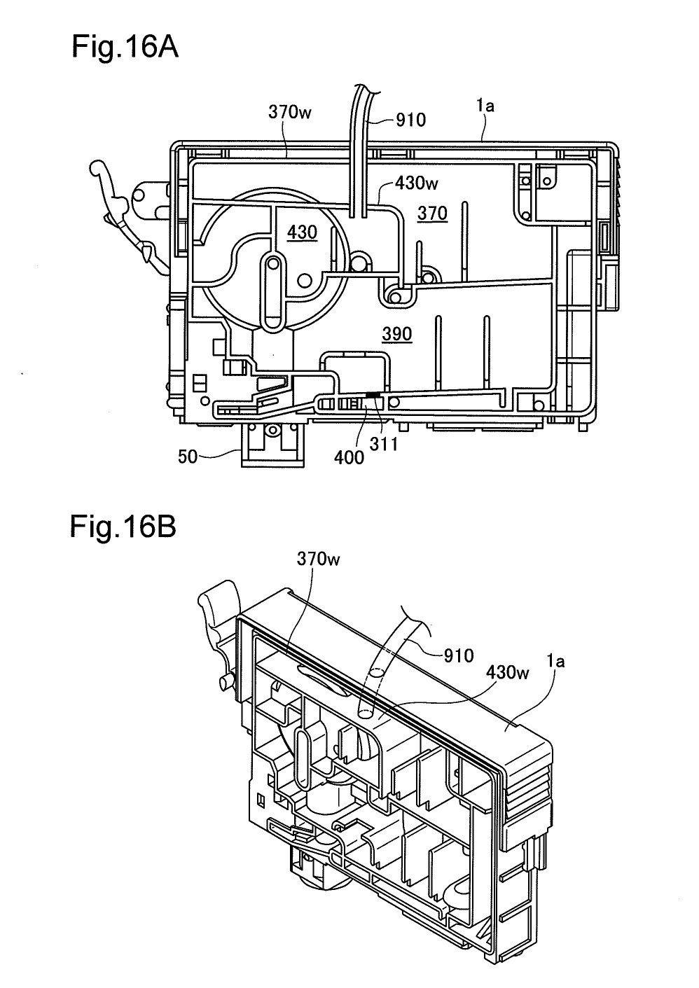

FIGS. 16A and 16B show a method of connecting an ink supply tube 910 to an ink cartridge in Embodiment 1. The ink supply tube 910 as a liquid flow passage member is passed through the top face 1a of the cartridge, the wall 370w in the upper part of the first ink holding chamber 370, and the wall 430w of the buffer chamber 430, so as to connect with and open into the buffer chamber 430. Ink supplied from the large-capacity ink tank 900 (FIG. 1B) will be introduced directly into the buffer chamber 430. In preferred practice the ink supply tube 910 will be made of flexible material.

The tube 910 connection operation is carried out by a procedure such as the following, for example. First, the ink cartridge and the tube 910 are prepared. The ink cartridge depicted in FIGS. 3 to 15A and various other cartridges are acceptable for this purpose. As depicted in FIG. 12, prior to connecting the tube 910, the ink holding chambers 370, 390 and the buffer chamber 430 of the cartridge are sealed by the film 80, with the cover member 20 sandwiching it from the outside (see FIG. 5). At this point, first, the cover member 20 will be detached, the film 80 will be partly or entirely peeled away, and holes will be made in the wall faces 1a, 370w, and 430w respectively. If the tube 910 is to be connected to the location shown in FIGS. 16A and 16B, it will be sufficient to peel off the section of the film 80 covering the first ink holding chamber 370, as it is possible to carry out the process without peeling the sections of the film 80 that cover the other chambers (the buffer chamber 430 and the second ink holding chamber 390). The tube 910 is then passed through the holes in the wall faces 1a, 370w, and 430w and fastened there. Fastening may be accomplished, for example, by applying an adhesive to the section of the tube 910 that will be pushed through the wall face 430w of the buffer chamber 430. This fastening operation will also effect sealing together of the tube 910 and the wall face 430w of the buffer chamber 430. Sealing together of the tube 910 with the other two wall faces la, 370w is optional. The communicating hole 311 that was made in the wall separating the second ink holding chamber 390 and the labyrinthine flow passage 400 is then closed off by injecting a filler material into it. Injection of this filler material may be carried out using a tool such as an injection syringe, and may be carried out through the film 80. The reason for closing off the communicating hole 311 is to prevent outside air (air bubbles) from being introduced through the air vent hole 100 (see FIG. 15B) from flowing into the sensor section 30, possibly causing the sensor section 30 to malfunction. The peeled section of the film 80 is then reattached, the ink is replenished if necessary, and the cover part 20 is then attached. This series of operations completes the operation to connect the tube to the ink cartridge. By then connecting the tube 910 to the large-capacity ink tank 900, the ink delivery system is complete.

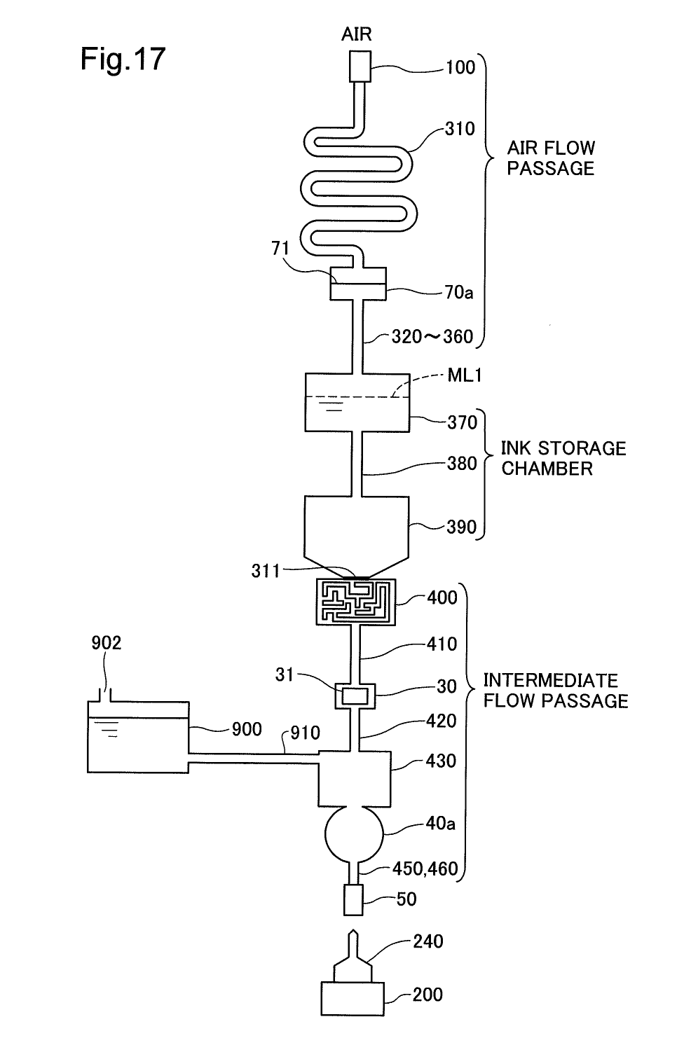

FIG. 17 is a conceptual depiction of the ink delivery system pathway in Embodiment 1. The large-capacity ink tank 900 has been connected to the buffer chamber 430 via the tube 910 so that ink may be delivered directly to the buffer chamber 430. Typically, the large-capacity ink tank 900 will be provided with an air vent hole 902 as well so that air may be introduced into the large-capacity ink tank 900 in association with declining ink level. Consequently, it will be possible for ink to be fed to the buffer chamber 430 from the large-capacity ink tank 900 at a suitable pressure level at all times.

It should be noted that the location of the buffer chamber 430, at the downstream side of the ink flow passages with high flow passage resistance (i.e. the labyrinthine flow passage 400 and the sensor section 30), has the advantage that the ink supplied from the large-capacity ink tank 900 need not pass through these ink flow passages 400, 30. If the tube 910 is connected upstream from the ink flow passages 400, 30 of high flow passage resistance, the flow passage resistance from the large-capacity ink tank 900 to the tube 910 will be compounded by the flow passage resistance of these ink flow passages 400, 30, with the possibility that sufficient ink may not be delivered to the print head. That is, as taught in the present embodiment, by connecting the tube 910 to the buffer chamber 430 on the downstream side of the sensor section 30, it will be possible for ink to be delivered to the print head at appropriate pressure. In this regard, it is possible for the tube 910 to be connected to any flow passage that is situated on the downstream side from the sensor section 30.

It should be also noted that the buffer chamber 430 is present to the upstream side of the differential pressure valve housing chamber 40a that houses the differential pressure valve 40. Consequently, it will be possible for ink supplied through the tube 910 to be delivered to the print head at stable pressure conditions, by utilizing the function of the differential pressure valve 40.

It should be further noted that in Embodiment 1, the communication hole 311 between the second ink holding chamber 390 and the labyrinthine flow passage 400 is closed off. As a result, air will be prevented from flowing into the sensor section 30 from the air vent hole 100. By so doing, it will be possible to avoid situations where inflowing air causes the sensor section 30 to mistakenly sense that no ink is present. It is possible for this closing off of the ink flow passage to be made at any location to the upstream side of the tube 910 connection site.

According to Embodiment 1, because the ink supply tube 910 is connected to the downstream side of the sensor section 30, the ink supplied from the tube 910 will be delivered to the print head of the printer without passing through the sensor section 30 which represents an ink flow passage with high flow passage resistance. It is accordingly possible to achieve stable ink delivery.

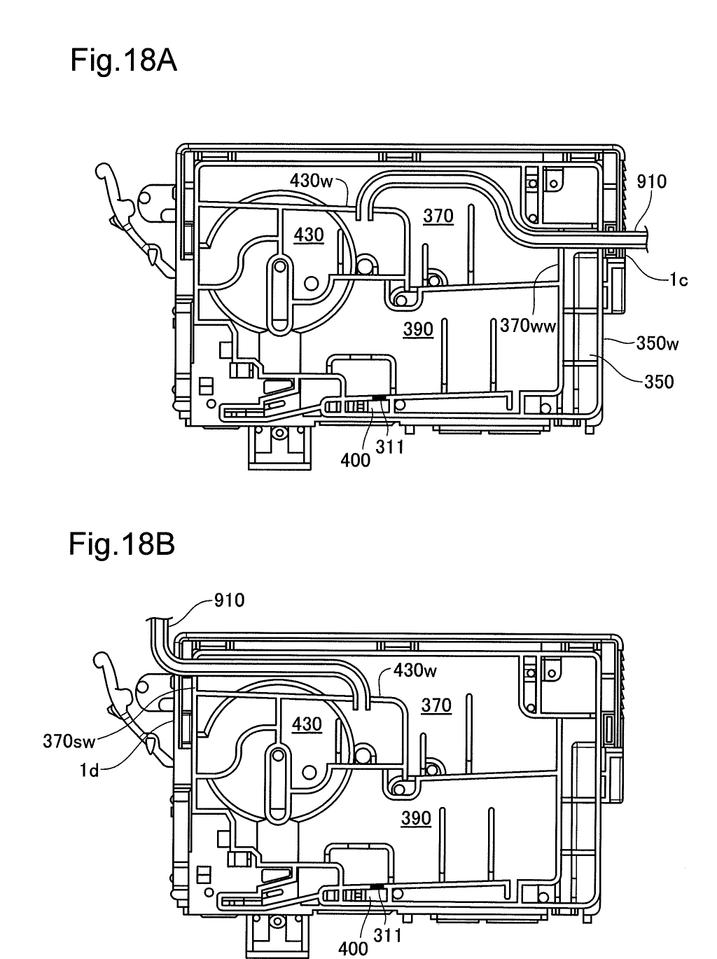

FIGS. 18A and 18B show modified examples of Embodiment 1. In a first modified example depicted in FIG. 18A, the tube 910 is passed through the right face 1c of the cartridge, the wall face 350w of the space 350 serving as an ink trap, and the wall face 370ww on the right side of the first ink holding chamber 370, and is pushed through the wall face 430w of the buffer chamber 430. In a second modified example depicted in FIG. 18B, the tube 910 is passed through the left face 1d of the cartridge and the left wall face 350sw of the first ink holding chamber 370, and is pushed through the wall face 430w of the buffer chamber 430. These modified examples share with the preceding Embodiment 1 the feature that ink is supplied directly to the buffer chamber 430 via the tube 910. Consequently, these modified examples afford advantages comparable to Embodiment 1.

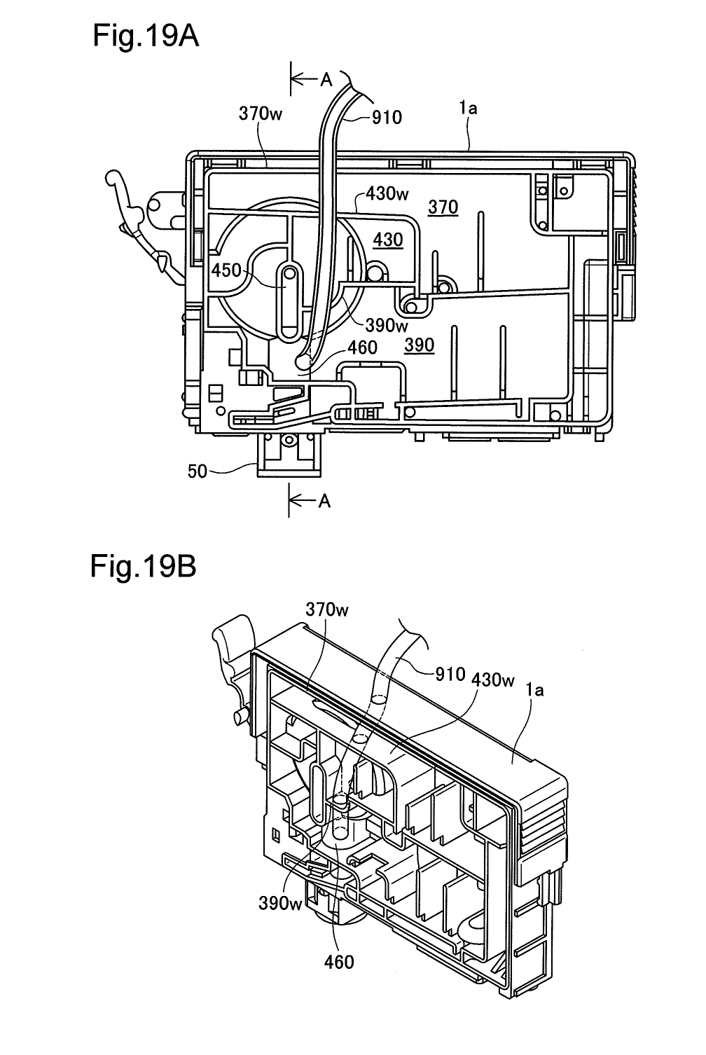

FIGS. 19A and 19B show a method of connecting an ink supply tube 910 to an ink cartridge in Embodiment 2. The ink supply tube 910 is passed through the top face 1a of the cartridge, the wall 370w in the upper part of the first ink holding chamber 370, the wall 430w of the buffer chamber 430, and the wall 390w between the buffer chamber 430 and the second ink holding chamber 390, so as to connect with the vertical flow passage 460. Consequently, ink supplied from the large-capacity ink tank 900 will be introduced directly into the vertical flow passage 460. Sealing of the zones between the tube 910 and the wall faces 1a, 370w, 390w is optional.

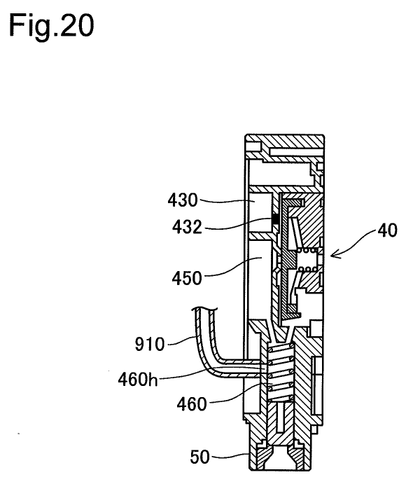

FIG. 20 is a drawing depicting the A-A cross section of FIG. 19A. The tube 910 is affixed with adhesive or the like in an opening 460h provided to the vertical flow passage 460. Consequently, ink supplied from the tube 910 will be directly conducted vertically downward from the vertical flow passage 460 and delivered to the print head of the printer via the liquid delivery port 50. In this example, the communication hole 432 connecting the buffer chamber 430 and the differential pressure valve 40 is closed off. In FIG. 20, for convenience in illustration, the communication hole 432 is depicted as being at a location somewhat further towards the upper side than in FIGS. 13A, 13B. The tube 910 is depicted in its condition prior to being installed within the cartridge.

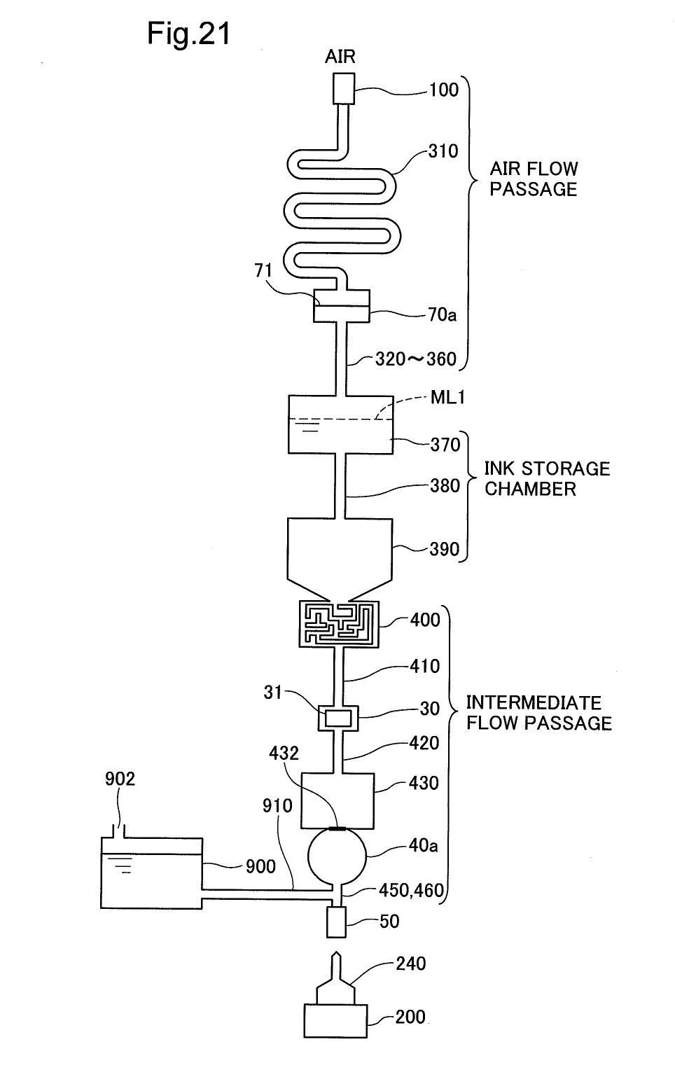

FIG. 21 is a conceptual depiction of the ink delivery system pathway in Embodiment 2. The large-capacity ink tank 900 has been connected to the vertical flow passage 460 via the tube 910 so that ink may be delivered directly to the vertical flow passage 460. Consequently, as ink is consumed by the printer, it will be possible for ink from the large-capacity ink tank 900 to be delivered commensurately to the print head of the printer via the vertical flow passage 460 and the liquid delivery port 50.

In Embodiment 2, as in Embodiment 1, it is preferable to prevent air from flowing into the sensor section 30 from the air vent hole 100. This is the reason for closing off the communication hole 432 which is situated upstream from the tube 910 connection location. It is possible for closing off of the ink flow passage to be done at any site upstream from the tube 910 connection location.

In Embodiment 2, because the tube 910 is connected to the downstream side of the differential pressure valve housing chamber 40a, the function of the differential pressure valve 40 is not utilized. Accordingly, in Embodiment 2, in order that ink may be supplied at appropriate pressure to the print head from the cartridge it is preferable to keep the pressure of the ink delivered from the large-capacity ink tank 900 within an appropriate pressure range. It is acceptable for example to furnish the large-capacity ink tank 900 with a pressure maintenance or regulating mechanism. As one exemplary pressure maintenance mechanism, it is possible to employ a mechanism whereby the ink tank 900 is moved up or down to maintain the liquid level therein within an fixed height range from the nozzle faces of the print head, irrespective of the ink level inside the large-capacity ink tank 900. In this case, the head differential from the nozzle face of the print head to the liquid level of the ink tank will preferably be within a range of about +100 mm and −500 mm. If this head differential is too great, the meniscus cannot be maintained at the nozzle face of the print head, and it is possible that ink will leak out inadvertently. On the other hand, if the head differential is too small, it is possible that a sufficient amount of ink cannot be delivered to the print head from the ink tank. In the case of an off-cartridge type ink-jet printer, however, since in most instances a differential pressure valve is provided to the print head, in such cases it will not be necessary to regulate the head differential between the large-capacity ink tank 900 and the print head.

In this way, in Embodiment 2, because the ink supply tube 910 has been connected downstream from the sensor section 30 in a manner comparable to Embodiment 1, ink supplied from the tube 910 will be delivered to the print head of the printer, making it possible to achieve stable ink delivery. Moreover, in Embodiment 2, in a manner analogous to the modified examples of Embodiment 1, it is possible for the tube 910 to be introduced from either the left or right wall face of the cartridge.

Although the tube 910 is connected to the vertical flow passage 460 in Embodiment 2, it is possible to obtain similar advantages by connecting the tube 910 to the other vertical flow passage 450 situated thereabove (see FIG. 19A). As long as the tube 910 is connected to either of the vertical flow passages 450, 460, even if air bubbles flow into the cartridge via the tube 910 the bubbles will rise through the vertical flow passages 450, 460 and become trapped in the differential pressure valve chamber. A consequent advantage is that the bubbles will be prevented from proceeding into the print head.

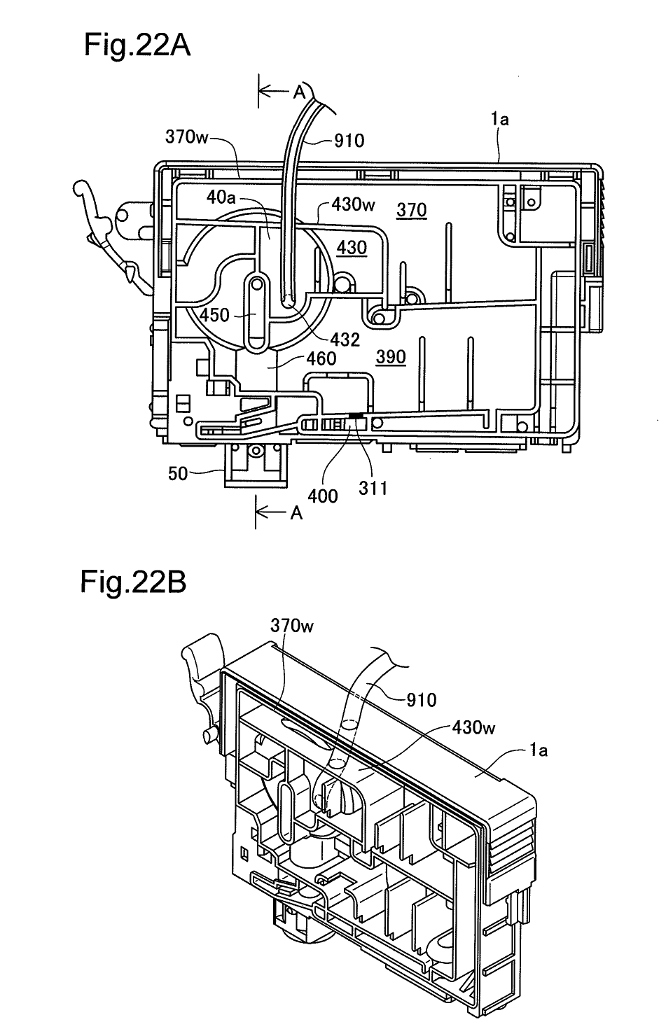

FIGS. 22A and 22B show a method of connecting an ink supply tube 910 to an ink cartridge in Embodiment 3. The ink supply tube 910 is passed through the top face 1a of the cartridge, the wall 370w in the upper part of the first ink holding chamber 370, and the wall 430w of the buffer chamber 430, so as to connect with the communication hole 432 between the buffer chamber 430 and the differential pressure valve housing chamber 40a. Consequently, ink supplied from the large-capacity ink tank 900 will be introduced directly into the differential pressure valve housing chamber 40a. In Embodiment 3, in the same manner as in Embodiment 1, the communication hole 311 between the second ink holding chamber 390 and the labyrinthine flow passage 400 is sealed. Sealing of the zones between the tube 910 and the wall faces 1a, 370w, 390w is optional.

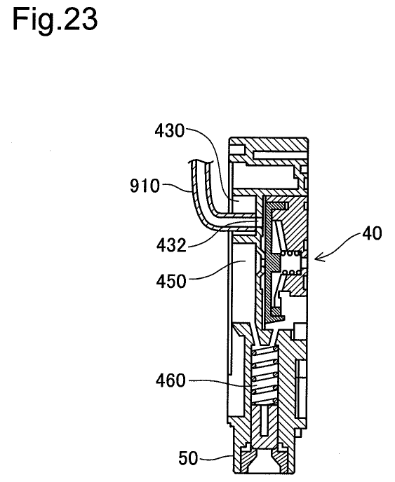

FIG. 23 is a drawing depicting the A-A cross section of FIG. 22A. The tube 910 is affixed with adhesive or the like in the communication hole 432 of the buffer chamber 430. In FIG. 23, for convenience in illustration, the communication hole 432 is depicted as being at a location somewhat further towards the upper side than in FIG. 22A. The tube 910 is depicted in its condition prior to being installed in the cartridge.

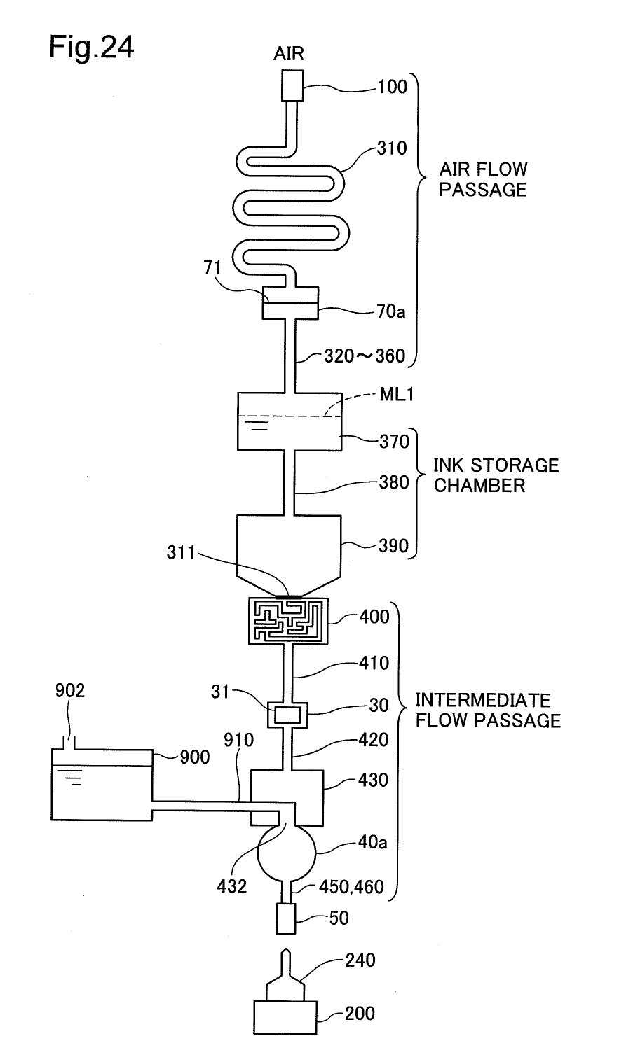

FIG. 24 is a conceptual depiction of the ink delivery system pathway in Embodiment 3. The large-capacity ink tank 900 has been connected to the differential pressure valve housing chamber 40a via the tube 910 so that ink may be delivered directly to the differential pressure valve housing chamber 40a. Consequently, as ink is consumed by the printer, the differential pressure valve 40 will open, and ink supplied from the large-capacity ink tank 900 will flow through the differential pressure valve 40 and the vertical flow passages 450, 460, and be delivered to the print head of the printer via the liquid delivery port 50.

In Embodiment 3, as in Embodiment 1, it is preferable to prevent air from flowing into the sensor section 30 from the air vent hole 100. This is the reason for closing off the communication hole 311 which is situated upstream from the tube 910 connection location. It is possible for closing off of the ink flow passage to be done at any site upstream from the tube 910 connection location.

In this way, in Embodiment 3 as well, because the ink supply tube 910 has been connected downstream from the sensor section 30 in a manner comparable to Embodiment 1, ink supplied from the tube 910 will be delivered to the print head of the printer without passing through the sensor section 30 which represents an ink flow passage with high flow passage resistance, making it possible to achieve stable ink delivery. Also, as in Embodiment 1, in Embodiment 3 the function of the differential pressure valve 40 is utilized when delivering ink from the large-capacity ink tank 900 to the print head side. Furthermore, in Embodiment 3, since the distal end of the tube 910 need simply be fastened into the communication hole 432 that has been provided beforehand to the cartridge, there is the advantage of a simple tube connection operation. Also, the tube 910 may be connected to another communication hole in the cartridge, instead of the communication hole 432. In this case as well, it will be preferable to connect the tube 910 to a communication hole that is situated on the downstream side of the sensor section 30. Moreover, in Embodiment 3, in a manner analogous to the modified examples of Embodiment 1, it is possible for the tube 910 to be introduced from either the left or right wall face of the cartridge.

### D. MODIFIED EXAMPLES

The present invention is not limited to the embodiments shown hereinabove, and may be reduced to practice in various other modes without departing from the spirit thereof, as in the possible modifications described below.

### D1. Modified Example 1

While the preceding embodiments describe various flow passages, holding chambers, and communication holes provided to the ink cartridges, some of these arrangements may be dispensed with.

### D2. Modified Example 2

While in the preceding embodiments, a large-capacity ink tank 900 is employed as the ink supply device, an ink supply device of some other configuration may be used. For example, it is possible to employ an ink supply device having a pump provided between the large-capacity ink tank 900 and the ink cartridge 1.

### D3. Modified Example 3

While the preceding embodiments have described an ink delivery system adapted for an ink-jet printer, the present invention is adaptable generally to liquid delivery systems that deliver a liquid to a liquid jetting device or a liquid consuming device; with appropriate modifications, it is possible for the invention to be employed in liquid consuming devices of various kinds equipped with a liquid jetting head adapted to eject small amounts of a liquid in drop form. Herein, a drop refers to the state of the liquid ejected from the liquid jetting device, and includes those with tails of granular, teardrop, or filiform shape. Herein, a liquid refers to any material that can be jetted from a liquid jetting device. For example, substances of any state when in the liquid phase would be acceptable including those of a high- or low-viscosity liquid state, of a fluid state such as a sol, gel water, or other inorganic solvent, organic solvent, solution, liquid resin, liquid metal (molten metal), or substances having the liquid state as one of their states; as well as materials containing particles of functional materials consisting of solids such as pigments or metal particles dissolved, dispersed, or mixed into a medium. Typical examples of liquids are the inks described in the preceding embodiments, and liquid crystals. Here, the term “ink” is used to include typical water based inks and oil based inks, as well as shellac, hot melt inks, and various other kinds of liquid compositions. Specific examples of liquid consuming devices are liquid jetting devices adapted to jet liquids containing materials such as electrode materials or coloring matter in dispersed or dissolved form, and employed in manufacturing liquid crystal displays, EL (electroluminescence) displays, plane emission displays, or color filters; liquid jetting devices adapted to jet liquids containing bioorganic substances used in biochip manufacture; liquid jetting devices adapted to jet liquids as specimens for use as precision pipettes; textile printing devices; or microdispensers. The system may further be employed as a delivery system in liquid jetting devices used for pinpoint application of lubricants to precision instruments such as clocks or cameras; in liquid jetting devices adapted to jet an ultraviolet curing resin or other transparent resin solution onto a substrate for the purpose of forming a micro semi-spherical lens (optical lens) for use in optical communication elements etc.; or in liquid jetting devices adapted to jet an acid or alkali etchant solution for etching circuit boards etc. The present invention is adaptable as a delivery system to any of the above types of liquid jetting devices. The liquid delivery systems that deliver liquid other than ink will employ a liquid flow passage member made of material suitable for the particular liquid, in place of the ink supply tube.

What is claimed is:

1. A method of manufacturing a liquid delivery system that delivers liquid to a liquid jetting device, comprising the steps of:
(a) providing a liquid receptacle that is installable on the liquid jetting device;
(b) providing a liquid supply device for supplying the liquid receptacle with the liquid; and
(c) connecting the liquid receptacle and the liquid supply device with a liquid flow passage member;
wherein the liquid receptacle has:
a liquid storage chamber that stores the liquid;
a liquid delivery port that delivers the liquid to the liquid jetting device;
an intermediate flow passage leading from the liquid storage chamber to the liquid delivery port; and
a sensor, disposed in the intermediate flow passage, for sensing whether the liquid is present or not,
wherein the step (c) includes connecting the liquid flow passage member to the intermediate flow passage at a connection location downstream of the sensor.

2. The method according to claim 1, wherein
the intermediate flow passage has a buffer chamber located downstream of the sensor, and
the liquid flow passage member is connected to the buffer chamber in the step (c).

3. The method according to claim 1, wherein
the intermediate flow passage includes:
a differential pressure valve housing chamber, disposed downstream of the sensor, for housing a differential pressure valve that opens and closes responsive to a differential pressure arising through consumption of the liquid; and
a vertical flow passage, disposed downstream of the differential pressure valve housing chamber, for leading the liquid to the liquid delivery port in the vertical direction,
wherein the liquid flow passage member is connected to the vertical flow passage in the step (c).

4. The method according to claim 1, wherein
the intermediate flow passage includes a liquid communication hole which is disposed downstream of the sensor and which is formed in a wall inside the liquid receptacle, and
the liquid flow passage member is connected to the liquid communication hole in the step (c).

5. The method according to claim 1, wherein
the liquid receptacle further includes an air flow passage that connects the liquid storage chamber to an outside air; and
the step (c) further includes closing off the air flow passage at a location upstream of the connection location of the liquid flow passage member to the intermediate flow passage.

6. A liquid delivery system that delivers liquid to a liquid jetting device, comprising:
a liquid receptacle that is installable on the liquid jetting device;
a liquid supply device that supplies the liquid receptacle with the liquid; and
a liquid flow passage member that connects the liquid receptacle with the liquid supply device,
wherein the liquid receptacle has:
a liquid storage chamber that stores liquid;
a liquid delivery port that delivers the liquid to the liquid jetting device;
an intermediate flow passage leading from the liquid storage chamber to the liquid delivery port; and
a sensor, disposed in the intermediate flow passage, for sensing whether the liquid is present or not,
wherein the liquid flow passage member is connected to the intermediate flow passage at a connection location downstream of the sensor.

7. A method of manufacturing a liquid receptacle for use in a liquid delivery system that delivers liquid to a liquid jetting device, wherein
the liquid receptacle is installable on the liquid jetting device, and the liquid receptacle has:
a liquid storage chamber that stores liquid;
a liquid delivery port that delivers the liquid to the liquid jetting device;
an intermediate flow passage leading from the liquid storage chamber to the liquid delivery port; and
a sensor, disposed in the intermediate flow passage, for sensing whether the liquid is present or not,
wherein the method includes the step of connecting a liquid flow passage member to the intermediate flow passage at a connection location downstream of the sensor, the liquid flow passage member being to be used to supply the liquid to the liquid receptacle from outside.
